(19) United States
(12) Patent Application Publication
(10) Pub. No.: US 2009/0271843 A1
(43) Pub. Date: Oct. 29, 2009

(54) INFORMATION FLOW CONTROL SYSTEM

(75) Inventors: Satoshi KAI, Yokohama (JP); Masato ARAI, Yokohama (JP); Yoshinobu TANIGAWA, Yokohama (JP); Hiromi IGAWA, Kawasaki (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 12/417,370

(22) Filed: Apr. 2, 2009

(30) Foreign Application Priority Data
Apr. 25, 2008 (JP) 2008-116211

(51) Int. Cl. G06F 21/00

(52) U.S. Cl. 726/1

(57) ABSTRACT

In an information control flow system, when a process reads a file with a second attribute after being through for reading of a file with a first attribute, when the second attribute is higher in level than the first attribute, a user is allowed to select first control with which the file with the second attribute is not made open, second control with which the file with the second attribute is made open after the file with the first attribute is closed, or third control with which the file with the second attribute is made open after the file with the first attribute is opened again for read-only purpose. When the user selects the first control, the first attribute is provided to a file to be written, and when the user selects the second or third control, the second attribute is provided to a file to be written.

### INCORPORATION BY REFERENCE

This application claims priority based on a Japanese patent application, No. 2008-116211 filed on Apr. 25, 2008, the entire contents of which are incorporated herein by reference.

### BACKGROUND

The subject matter discussed herein relates to an information flow control system that provides an attribute to information resources under an in-house rule such as document management, and while inheriting the attribute, applies a policy including the in-house rule enforcement in accordance with the attribute.

Information in the possession of corporate organizations, e.g., identity information, trade secret, and technology information, has recently often been converted into electronic form. The problem here is that the resulting information resources in electronic form are easily exposed to the risk of security threats such as information leakage, because the contents thereof suffer no degradation even if they are replicated or transferred, or replication or transfer thereof hardly leaves indicative evidence. Such security risk threats directly lead to problems in view of business procedures. For example, if leakage of identity information occurs, the corporate organization will be blamed for the inadequacies of the management system for the identity information, and their stock price may suffer. If leakage of any new technology information occurs, the information may become available for competitors, and thus the new product may not be competitive enough. As such, the importance of appropriately managing the information resources in the electronic form has been increasingly growing compared with the days before Information Technology when information resources were managed in the form of paper.

For measures thereagainst, technologies for ensuring the information security have been developed at a rapid pace. Such technologies vary in type, e.g., user identification/authentication technology, encryption technology, network access control technology, and computer access control technology. The corporate organizations have started to combine together such information security technologies so as to enhance the security of their information resources.

The issue here is that such varying combinations of the information security technologies are known to cause a further reduction of convenience for employees. For example, if such measures are taken as prohibiting data writing from employees' desktop personal computers (PCs) to transportable media such as USB (Universal Serial Bus) memory, it means that the employees such as sales representatives cannot take any needed information with them to be on the road, thereby resulting in a reduction of convenience. If other measures are taken as requiring boss's permission for file attachment to e-mails for people outside of the office, it results in the increase of work burdens on the boss who is supposed to concentrate attention on the profit-making work as is earning a high hourly wage. Moreover, taking such various information security measures together causes another problem of encouraging technically-literate employees to seek a way thereagainst. For example, if data writing to transportable media is prohibited, such employees may find a way of using their PDAs (Personal Digital Assistants) or mobile phones to take out information resources, or to avoid being checked for attachment files, they may find their original way of encoding files to enable file attachment to a text of mails. As such, taking various information security measures together is not enough to appropriately manage information resources.

In consideration thereof, as simpler measures, an understanding of the type of the information resources is needed in advance to manage appropriately the information resources. International Publication Pamphlet No. WO 2006/122086 (hereinafter, referred to as Patent Document 1) describes a technology for signature computation to determine whether there is any highly-confidential information in files or not, i.e., text data in a file is analyzed to compute a signature of its own of a fixed length, and the degree of matching is computed between the resulting signature and other signatures found in a black list. When the file includes highly-confidential information of a fixed amount or more, for example, a policy is applied to prohibit data writing to USB memories or file attachment to e-mails, for example. Because such application of a policy is determined based on the degree of matching between the signatures, when there are a plurality of signatures showing the same degree of matching, a plurality of policies are accordingly applied.

Another International Publication Pamphlet No. WO 2006/137057 (hereinafter, referred to as Patent Document 2) describes a technology for providing a tag to text data of a fixed size, and inheriting the tag by checking whether the text data is to be subjected to low-level file I/O (Input/Output) processing or not. When the text data in a file is found as being provided with a tag, a policy is applied to prohibit data writing to USB memories or file attachment to e-mails, for example. Because such application of a policy is determined based on a tag provided to text data in a file, when the file has a plurality of tags, a plurality of policies are applied accordingly.

### SUMMARY

To protect files from data leakage, there is a need to appropriately control the files in accordance with attributes, which are provided to the files to suit the contents thereof. Such attributes are exemplified by a security level and a category. To control the files in a manner suiting the contents thereof as such, there also is a need to propagate or inherit the attributes appropriately to various operations such as file overwriting, and data saving under a different file name. The concern here is that, after opening a file with an attribute, for storing the file under a new file name after data overwriting, determining which attribute is to be provided thereto will be especially difficult.

Exemplified here is a case where a process with MDI (Multiple Document Interface) reads a file with an attribute indicating that the file is highly confidential (hereinafter, such an attribute is referred to as “highly-confidential attribute”), there is a file with an attribute indicating that the file is general (hereinafter, such an attribute is referred to as “general attribute”), and the process stores a new file A under a different new file name. In this case, the contents of the file A are supposed to be used as a basis to determine which policy is to be applied thereto, i.e., a policy for the highly-confidential attribute or a policy for the general attribute.

With the technology of Patent Document 1, however, the determination factor about control over the file A is the degree of matching between the file with the highly-confidential attribute and the file with the general attribute. This may possibly cause the file A to be under the two types of control, i.e., control for the highly-confidential attribute and control for the general attribute. Moreover, with the technology of Patent Document 2, the determination factor about the attribute of the file A is a tag in text data attached thereto, and this also may cause the file A to be under the two types of control, i.e., control for the highly-confidential attribute and control for the general attribute. If a file is put under a plurality types of control, the control with more severity is generally applied. As a result, if various types of control are to be applied to a single file, the resulting control may be excessive, thereby reducing the efficiency of business operations.

Exemplified also is a case where, between a process P that is already through with reading of a file with the highly-confidential attribute and a process Q that is already through with reading of a file with the general attribute, the process Q stores a new file B after data copying and pasting from the process P to Q via a shared memory. In this case, the contents of the file B are supposed to be used as a basis to determine which policy is to be applied thereto, i.e., a policy for the highly-confidential attribute or a policy for the general attribute.

With the technology of Patent Document 1, however, the determination factor about control over the file B is the degree of matching between the file with the highly-confidential attribute and the file with the general attribute. This thus may possibly cause the file B to be under two types of control, i.e., control for the highly-confidential attribute and control for the general attribute. Moreover, with the technology of Patent Document 2, the determination factor about the attribute of the file B is a tag in text data attached thereto, and this also may cause the file B to be under the two types of control, i.e., control for the highly-confidential attribute and control for the general attribute.

Again, if a file is put under a plurality types of control such, the control with more severity is generally applied. As a result, if various types of control are to be applied to a single file, the resulting control may be excessive, thereby reducing the efficiency of business operations.

In consideration thereof, the present information flow control system can store any two of a plurality of open files varying in attributes, and can propagate or inherit the attribute that is suitable to each of the files.

In an example, a disclosed system is directed to an information flow control system that provides an attribute to a file, and controls data transfer between the file and others varying in attributes. The system includes: process monitor means for process identification to know which process is started or ended, and keeping track of a list of processes in progress; file read means for detecting, at the time of file reading, the attribute provided to the file that is being read; and file write means for, at the time of file writing, providing the attribute to the file that is being read.

In an aspect of one such system, when the process reads a file with a second attribute after being through for reading of a file with a first attribute, when the second attribute is higher in level than the first attribute, a user is allowed to select from among three types of controls. With first control, the file read means does not make the file with the second attribute open. With the second control, the file read means makes the file with the second attribute open after closing the file with the first attribute. With the third control, the file read means makes the file with the second attribute open after opening again the file with the first attribute for read-only purpose. When the user selects the first control, thereafter, the file write means provides the first attribute to a file to be written by the process. When the user selects the second or third control, thereafter, the file write means provides the second attribute to a file to be written by the process.

In another aspect, alternatively, when the process reads a file with a second attribute after being through for reading of a file with a first attribute, when the second attribute is lower in level than the first attribute, a user is allowed to select from among several types of control. With one control, the file read means does not make the file with the second attribute open. With another control the file read means makes the file with the second attribute open after changing the attribute thereof to the first attribute. With yet another type of control the file read means makes the file with the second attribute open for read-only purpose. Thereafter, the file write means provides the first attribute to a file to be written by the process.

In another aspect, further, when the process reads a file with a second attribute after being through for reading of a file with a first attribute, when the second attribute is different in category from the first attribute, a user is allowed to select from a set of controls. Here with one control, the file read means does not make the file with the second attribute open. Another type of control enables the file read means to make the file with the second attribute open after opening again the file with the first attribute for read-only purpose. With a further control, the file read means makes the file with the second attribute open for read-only purpose. If the user selects the first or third of these controls, thereafter, the file write means provides the first attribute to a file to be written by the process. When the user selects the other control, thereafter, the file write means provides the second attribute to a file to be written by the process.

The information flow control system may also include: shared memory copy detection means for detecting copying to a shared memory; and shared memory paste detection means for detecting pasting from the shared memory. In such an example of the system, a second process that is through with reading of the file with the second attribute performs pasting from the shared memory after a first process performs copying to the shared memory from the file with the first attribute. If the second attribute is higher in level than the first attribute, the shared memory paste detection means performs a control for giving permission to pasting, and thereafter, the file write means provides the second attribute to a file to be written by the second process.

Alternatively, when a second process that is through with reading of the file with the second attribute performs pasting from the shared memory after a first process performs copying to the shared memory from the file with the first attribute, if the second attribute is lower in level than the first attribute, a user is allowed to select from further control options. In this example, one control type would not allow the shared memory paste detection means to perform pasting. Another available control would allow the shared memory paste detection means to perform pasting, after changing the file with the second attribute to have the first attribute. When the user selects the first of these two further controls, thereafter, the file write means provides the second attribute to a file to be written by the second process. When the user selects the other of these two controls, thereafter, the file write means provides the first attribute to a file to be written by the second process.

In a further example, when a second process that is through with reading of the file with the second attribute performs pasting from the shared memory after a first process performs copying to the shared memory from the file with the first attribute, and the second attribute is different in category from the first attribute, then the shared memory paste means performs a control with no pasting. Thereafter, the file write means provides the second attribute to a file to be written by the second process.

In a still further example, when a process writes a new file with no file reading, a user is allowed to select a control with which the file write means creates no new file, or a control with which the file write means creates a file after provision of the attribute. When the user selects the later control type, then the file write means provides the attribute to a file to be written by the process.

With such configurations as above, for storing a file under a new file name after overwriting of data from any two of a plurality of open files having different attributes, there are advantages of being able to manage attribute inheritance suiting the contents of the file without causing control to be excessive. This allows easy understanding of the correlation between attributes and policies. Therefore, a user can understand how to handle the file only by knowing the attribute thereof, and an operator can easily determine which policy to apply in accordance with the attribute. This leads to other advantages of preventing, for handling information resources with various attributes on a desktop PC or the like, the attributes from being mixed up for provision to the information resources, and managing the information resources with an explicit indication how to handle the resources.

There are also advantages of being able to, for converting a file including text data into a binary file, e.g., encryption or imaging, inherit the same attribute for data reading and writing by the same process. There are other advantages of being able to, for copying and pasting image data via a shared memory, inherit the same attribute between files being the results of data reading and writing.

This is not restrictive to file writing from a process but also for printing from the process, there are also advantages of being able to, for printing to allow visual check of an attribute on the resulting printed material, inherit the same attribute for the read file and the printed material.

According to the teaching herein, for storing any two of a plurality of open files varying in attributes, the attribute that is suitable to each of the files can be inherited.

The systems as outlined above may be implemented as various combinations of hardware and software for implementing the information flow control. System hardware may comprise special purpose hardware or one or more general purpose devices programmed to implement the information flow control-related functions. A software product includes at least one machine-readable medium and information carried by the medium. The information carried by the medium may be executable program code for causing a programmable device to implement the information flow control-related functions.

These and other benefits are described throughout the present specification. A further understanding of the nature and advantages of the disclosed information flow control may be realized by reference to the remaining portions of the specification and the attached drawings.

### BRIEF DESCRIPTION OF THE DRAWINGS

FIG. 1 is a diagram, showing an information flow control system in its entirety;

FIG. 2 is a block diagram showing the program configuration of an agent;

FIG. 3 is a block diagram showing the hardware configuration of a client;

FIGS. 4A and 4B are data diagrams respectively showing the data configurations of policies;

FIGS. 5A to 5C are data diagrams respectively showing the data configurations of a process management table, a READ file management table, and a shared memory management table;

FIG. 6 is a data diagram showing the data configuration of event information;

FIG. 7 is a flowchart diagram of the operation of a process monitor program;

FIG. 8 is a flowchart diagram of the operation of a file access monitor program;

FIGS. 9A to 9C are each a diagram showing an exemplary user interface;

FIG. 10 is a flowchart of the operation of a shared memory monitor program;

FIGS. 11A and 11B are each a diagram showing an exemplary user interface;

FIG. 12 is a flowchart diagram of the operation of a policy enforcement application program;

FIG. 13 is a flowchart of the operation of a file access monitor program in a second embodiment; and

FIG. 14 is a diagram showing an exemplary user interface in the second embodiment.

### DETAILED DESCRIPTION OF THE EMBODIMENTS

### First Embodiment

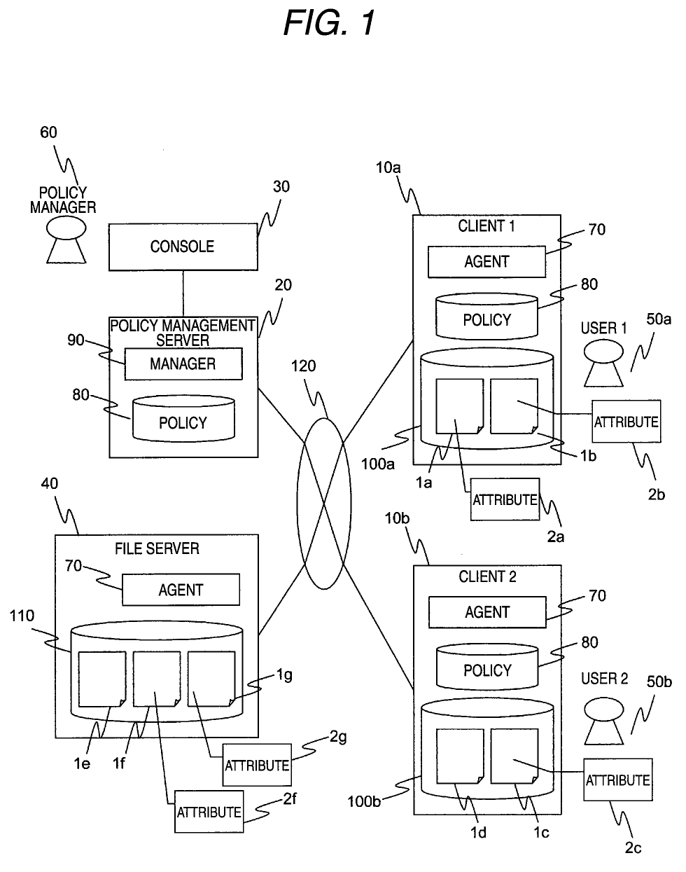

A description will be given mainly by referring to the block diagrams of FIGS. 1 to 3 of the information flow control concepts. FIG. 1 is a diagram showing an information flow control system. The information flow control system is of a configuration in which one or more clients 10a and 10b and a policy management server 20 are all coupled to a network 120. The policy management server 20 is coupled to a console 30, and using this console 30, a policy manager 60 works for management. The clients 10 are each coupled to a file server 40. Users 50a, 50b utilize the clients 10a, 10b to access and process files 1a to 1g which are the information resources on the file server 40, essentially to allow the users 50 to conduct business operations.

Attributes 2 are each provided to the files 1 in local storage devices 100 on the clients 10 and in a remote storage device 110 on the file server 40. Agents 70 are each in charge of providing and inheriting the attributes 2, and performing control based on policies 80 respectively in accordance with the attributes 2. The policies 80 are under the management of a manager 90 in the policy management server 20, and are distributed to the clients 10a and 10b over the network 120.

Herein, the attributes 2 for provision to the files 1 are stored in any of the following locations or combinations thereof:

in a file system by embedding into an extended file attribute therein,

in a file system by embedding into an i-node region therein,

in a file system by embedding into an alternative data stream therein,

in a file by direct embedding thereinto (header region or entity region), and

by embedding as document attribute when the files are document files.

Such attributes 2 are not guaranteed to be inherited by general copying and transfer.

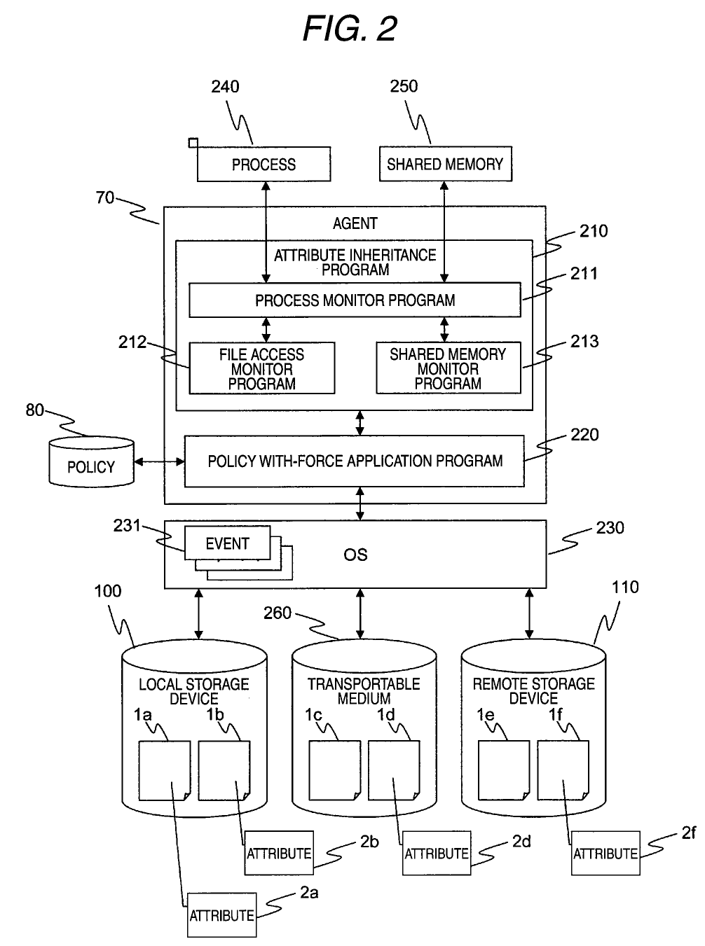

FIG. 2 is a diagram showing the program configuration of the agent 70. The agent 70 includes an attribute inheritance program 210, and a policy enforcement application program 220. The attribute inheritance program 210 is to propagate the attributes 2 to modified or newly derived files so that those files “inherit” the appropriate attributes, and the policy enforcement application program 220 is to perform control based on the policies 80 respectively in accordance with the attributes 2.

The attribute inheritance program 210 also includes a process monitor program 211, a file access monitor program 212, and a shared memory monitor program 213. The process monitor program 211 is to monitor a process 240 to start and end, and the file access monitor program 212 is to monitor any file access from the process 240 to the local storage devices 100, or to the remote storage device 110 and a transportable medium 260. The shared memory monitor program 213 is to monitor data copying and pasting by the process 240 to a shared memory 250.

The policy enforcement application program 220 monitors various events 231 to be occurred on an OS (Operating System) 230, and checks these events against the policies 80, thereby controlling the events 231.

Note that, in the clients 10, even if the agents 70 are not provided, the business operations can be conducted by utilizing the files 1 on their local storage devices 100. Herein, when the agents 70 are not provided, the attributes 2 of the files 1 are not inherited, and no control is performed in accordance with the policies 80.

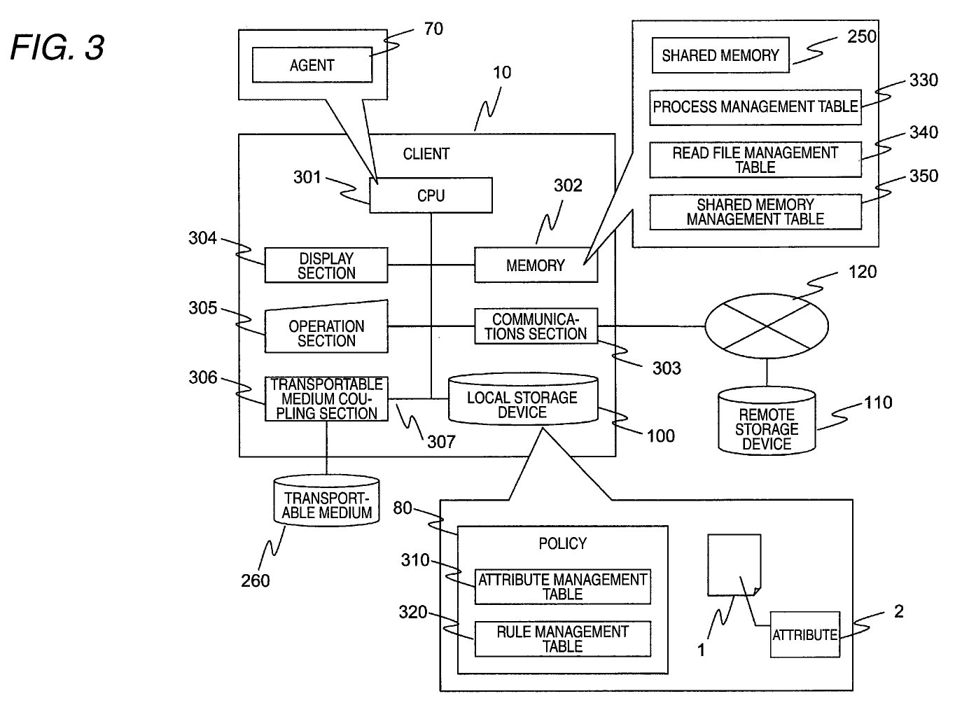

FIG. 3 is a diagram showing the block configuration of the client 10. The client 10 has a hardware configuration, including a processing section serving as a CPU (Central Processing Unit) 301, a memory 302, the local storage device 100, a communications section 303, a display section 304, an operation section 305, and a transportable medium coupling section 306, which are coupled together via a bus 307. The CPU 301 is in charge of controlling the clients 10, and data calculation and processing. The client device includes program and data storage media, such as the local storage device 100 and a memory 302. The memory 302 serves to temporarily store data and programs in the client 10, and is available for direct reading and writing by the CPU 301. The local storage device 100 is provided for storage of data and programs such as the files 1 not to be lost when the client 10 is turned off. The communications section 303 performs communications with the network 120 and the remote storage device 110 by cable or radio. The display section 304 is provided for display of, for a user 50, results of data calculation/processing on a display thereof. The operation section 305 is provided for accepting inputs from the user 50 made using a keyboard and a mouse, for example. The transportable medium coupling section 306 is for use of reading and writing of data stored in the transportable medium 260, for example.

The programming forming the agent 70 is loaded into the memory 302 for execution processing by the CPU 301, e.g. from local storage device 100. The shared memory 250 is a portion of the memory 302 is allocated on a temporary basis. The memory 302 also stores, on a temporary basis, a process management table 330, a READ file management table 340, and a shared memory management table 350, which will be all described later. The policy 80 is stored on the local storage device 100. The policy 80 includes an attribute management table 310, and a rule management table 320, which will be described later.

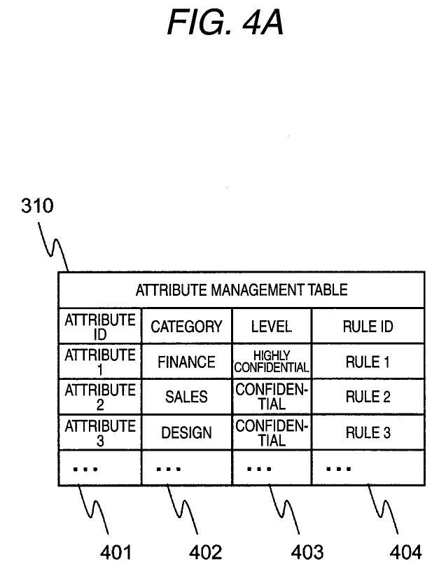

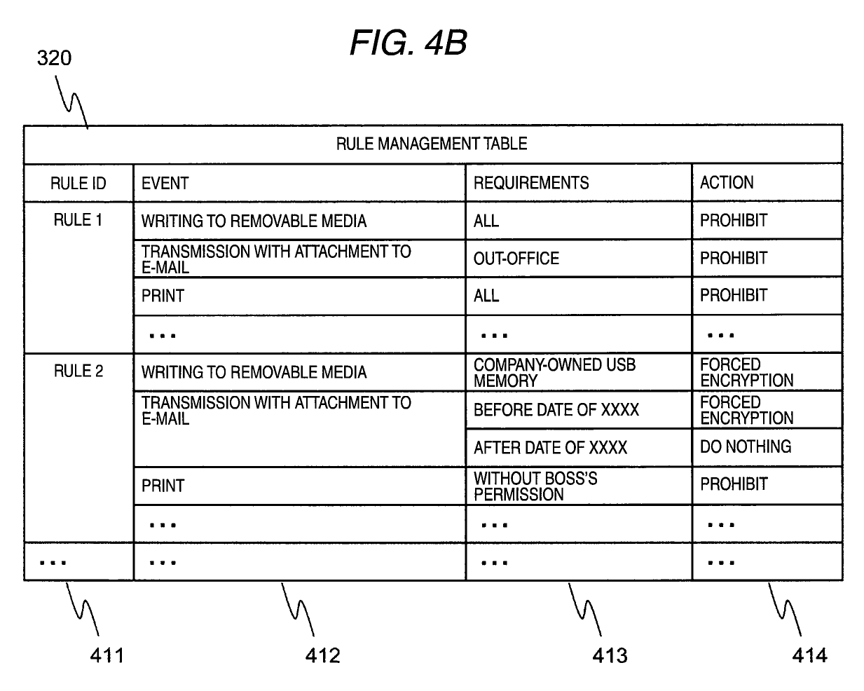

Another description is given mainly by referring to data diagrams of FIGS. 4A to 6. FIGS. 4A and 4B are diagrams respectively showing the data configuration of the policy 80. The policy 80 includes the attribute management table 310 of FIG. 4A, and the rule management table 320 of FIG. 4B.

The attribute management table 310 includes a plurality of entries, each of which is a combination of elements of “attribute ID 401”, “attribute category 402”, “attribute level 403”, and “rule ID 404”. The element of “attribute category 402” is provided for classification purpose not to mix up information during handling of information resources. The element of “attribute level 403” is about a security level defined for handling of the information resources.

The rule management table 320 includes a plurality of entries, each of which is a combination of elements of “rule ID 411”, “event 412” being a target for the rule, “requirements 413” under the rule, and “action 414” to be taken when the event in the element of “event 412” satisfies the requirements in the element of “requirements 413”. Note here that the element of “rule ID 411” has a one-to-multiple relationship with the element of “event 412”, and the element of “event 412” also has a one-to-multiple relationship with the element of “requirements 413”. Moreover, the element of “requirements 413” has a one-to-one relationship with the element of “action 414”.

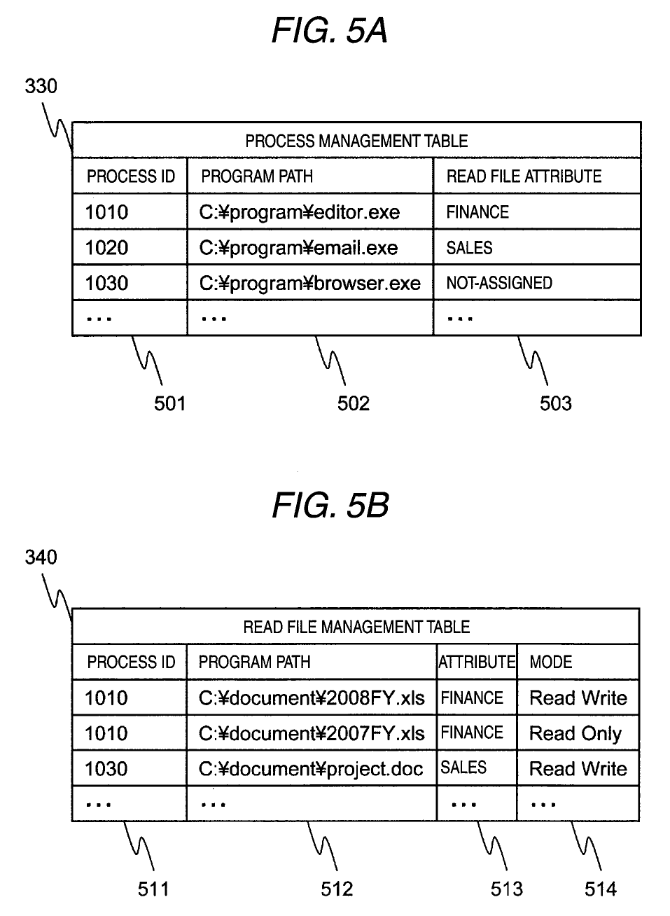

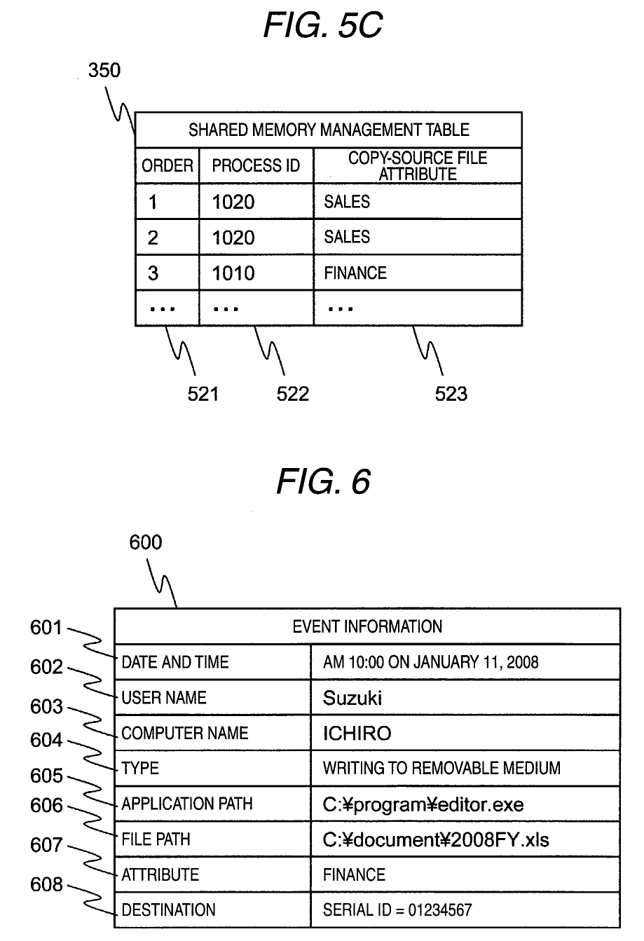

FIGS. 5A to 5C are diagrams respectively showing the data configurations of the process management table 330, that of the READ file management table 340, and that of the shared memory management table 350.

The process management table 330 is used for managing a list of processes that are in progress on the client 10. As shown in FIG. 5A, the process management table 330 includes a plurality of entries, each of which is a combination of elements of “process ID 501”, “program path 502”, and “READ file attribute 503” indicating the attributes of one or more files that have been read so far by the process.

The READ file management table 340 is used for managing a list of files read by processes that are in progress. As shown in FIG. 5B, the READ file management table 340 includes a plurality of entries, each of which is a combination of elements of “process ID 511”, “file path 512” indicating the paths of files read by the process, “attribute 513” indicating the attributes of the files, and “mode 514” for designating the behavior during file reading. Note that, in the first embodiment, the element of “mode 514” is not used.

The shared memory management table 350 is used for managing the contents of a plurality of copies for the shared memory 250 in which processes perform copying and pasting. As shown in FIG. 5C, the shared memory management table 350 includes a plurality of entries, each of which is a combination of elements of “stack order 521”, “process ID 522” through with copying to the shared memory 250, and “copy-source file attribute 523” indicating the element of “READ file attribute 503” corresponding to the process.

FIG. 6 is a diagram showing the data configuration of event information 600, which is the monitoring result by the policy enforcement application program 202 for the event 231 occurred in the OS 230. The event information 600 includes elements of “date and time 601”, “user name 602”, “computer name 603”, “type 604”, “application path 605”, “file path 606”, “attribute 607”, and “destination 608”.

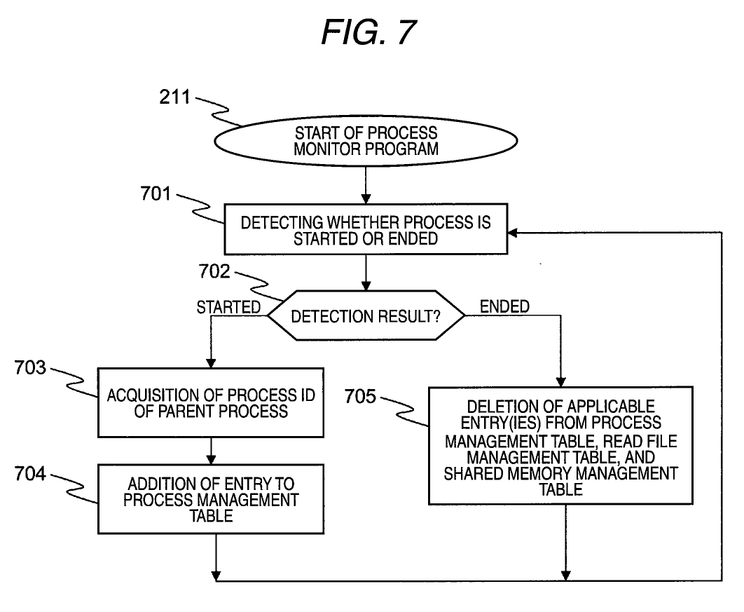

Next, a description is given mainly by referring to the flowchart diagrams of FIGS. 7 to 12. FIG. 7 is the flowchart diagram of the operation of the process monitor program 211.

(Step 701) After starting running, the process monitor program 211 detects processes to start and end on the client 10.

(Step 702) The detection result of step 701 is used as a basis to branch the process monitor procedure thereafter.

(Step 703) When the detection result of step 702 tells that the process is started, the process ID of a parent process of the detected process is acquired. In step 703, exemplified is a case where file reading and writing is performed by a child process derived from the parent process. Herein, when file reading and writing is performed by the same process, the procedure skips step 703.

(Step 704) The process ID acquired in step 703 is added to the process management table 330. The element of “READ file attribute 503” stores therein “not assigned”.

(Step 705) The entry corresponding to the process ID acquired in step 701 is deleted from the tables, i.e., the process management table 330, the READ file management table 340, and the shared memory management table 350.

After these steps are completed, the procedure returns to step 701 again, and the next process is monitored to start and end. Until the client 10 is turned off, the procedure repeats steps 701 to 705.

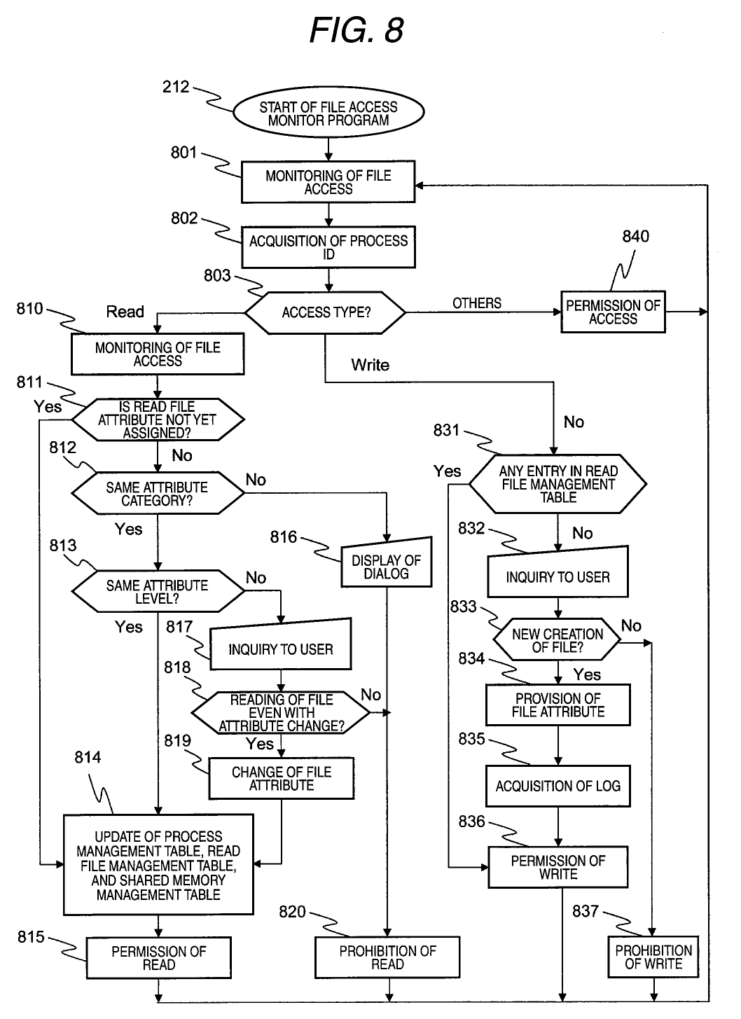

FIG. 8 is the flowchart diagram of the operation of the file access monitor program 212.

(Step 801) When starting running, the file access monitor program 212 monitors any file access on the client 10.

(Step 802) A process ID is acquired for the process, which is the main process performing the file access operation that was detected in step 801.

(Step 803) The access type of the file access detected in step 801 is used as a basis to branch the file access monitor process thereafter.

Described first is the procedure when the access type is READ.

(Step 810) When the access type is defined as being READ in step 803, the attribute 2 of the file being an access target is detected.

(Step 811) For the process ID acquired in step 802, the element of “READ file attribute 503” of the process is checked in the process management table 330, and based on the element of “READ file attribute 503”, the procedure branches thereafter. When the element of “READ file attribute 503” indicates “not assigned”, the procedure goes to step 814 that will be described later, and otherwise the procedure goes to step 812 that will be described later.

(Step 812) A comparison is made between the category of the element of “READ file attribute 503” acquired in step 811, and the category of the attribute 2 acquired in step 810.

(Step 813) After step 812 is completed, another comparison is made in terms of attribute level.

(Step 814) When this step is to be executed after step 811, the attribute 2 detected in step 810 is stored in the following two tables:

in the process management table 330, into the element of “READ file attribute 503”, and in the READ file management table 340, into the element of “attribute 513”.

When this step is to be executed after step 813, the attribute 2 detected in step 810 is stored in the READ file management table 340, into the element of “attribute 513”.

When this step is to be executed after step 819 that will be described later, the attribute 2 detected in step 810 is stored into the following three tables:

in the process management table 330, into the element of “READ file attribute 503”,

in the READ file management table 340, into the element of “attribute 513”, and

in the shared memory management table 350, into the element of “copy-source file attribute 523”.

(Step 815) A permission is given to the file access with the access type of READ.

(Step 816) When no category matching is derived in step 812, a dialog is displayed in the user 50.

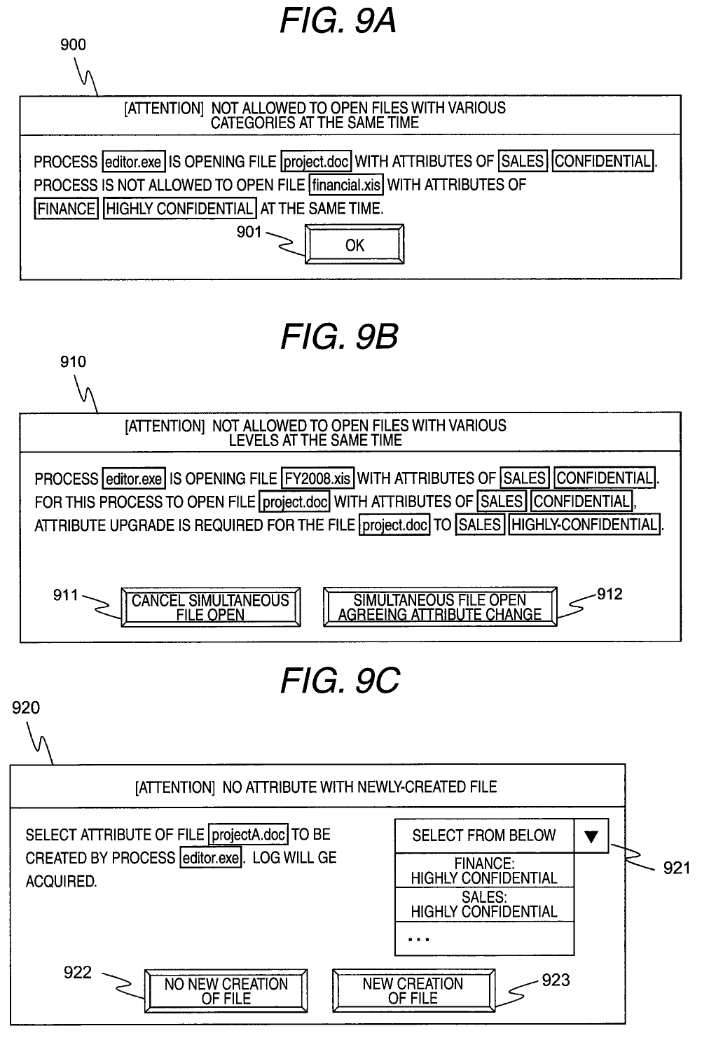

FIG. 9A is the diagram showing an exemplary dialog box 900 for display to the user 50, in step 816. The dialog box 900 indicates a message telling that the files with no category matching cannot be both left open, and the user is allowed only to depress a button 901 for “OK”.

(Step 817) When no level matching is derived in step 813, an inquiry is made to the user 50.

FIG. 9B is the diagram showing an exemplary dialog box 910 for making an inquiry to the user 50, in step 817. The dialog box 910 indicates a message telling that the files with various levels cannot be both left open, and displays therein buttons 911 and 912. The button 911 is provided for not to leave open the files with various attributes, and the button 912 is for to leave open such files after the user becomes aware of the need for such an attribute change.

(Step 818) The response from the user 50 in step 817 is used as a basis to branch the procedure thereafter.

(Step 819) When the user agrees in step 817 to open the files even with the change of the attribute 2, that is, when the user depresses the button 912 of FIG. 9B, the attribute 2 of the file 1 that is the target of the file access detected in step 801 is changed to a new attribute, which is approved in the dialog 910.

(Step 820) Any file access with the access type of READ is blocked, i.e., this is the procedure to be executed after step 816, or the procedure when the user 50 decided not to leave open the files in step after step 818, that is, the procedure after the user depresses the button 911 of FIG. 9B.

Described next is the procedure when the access type is defined as being WRITE.

(Step 831) For the file that is an access target of the file access detected in step 801, a determination is made whether the element of “file path 512” in the READ file management table 340 includes any same file path or not. When there is no such same file path, it is determined that a new file is created.

(Step 832) When the determination in step 831 tells that there is no applicable entry in the READ file management table 340, i.e., when a new file is created, an inquiry is made about the attribute for provision to the new file to the user 50.

FIG. 9C is the diagram showing an exemplary dialog box 920 at the time of making an inquiry to the user 50 in step 832. The dialog box 920 displays a message telling that a file to be newly created no attribute yet, and includes therein buttons 923 and 922. The button 923 is for the user to select an attribute from a pull-down menu 921 for creating a new file. The button 922 is for selection not to create a new file.

(Step 833) The response from the user 50 in step 832 is used as a basis to branch the procedure thereafter.

(Step 834) The attribute selected by the user from the pull-down menu 921 is provided to the file being a target of the file access detected in step 801, i.e., this is the procedure when the user depresses the button 923 in step 832 for creating a new file.

Note here that the file is not the only option for provision of an attribute, and any printed material will also do. If with a printed material, in step 834, the attribute may be printed to the printed material to allow visual check thereof.

(Step 835) The attribute provided in step 834 is logged (the log is not shown).

(Step 836) A permission is given to the file access with the access type of WRITE.

(Step 837) A prohibition is issued to the file access with the access type of WRITE, i.e., this is the procedure when the user 50 depresses the button 922 so as not to create a new file in step 832.

Described next is the procedure with the access type other than READ and WRITE.

(Step 840) A permission is given to the file access.

After those steps are completed, the procedure returns to step 801 again, and the next file access is monitored. Until the client 10 is turned off, the procedure from steps 801 to 840 is repeated.

With the procedure executed by the file access monitor program 212, when a process makes an attempt to open files with various attributes all at once, the control as shown in Table 1 is implemented over the file access, for example.

TABLE 1

| Attribute of File | Attribute of File to be | |
|---|---|---|
| Being Opened by | Opened Next by Process | Control Over File |
| Process | Same as Left | Access |
| Confidential | Highly | Not Allow to Open |
| | Confidential (Same | Highly-Confidential |
| | Category as Left) | File |
| Highly Confidential | Confidential (Same | Not Allow to Open |
| | Category as Left) | Confidential File, or |
| | | Open After Changing |
| | | Attribute from |
| | | Confidential to |
| | | Highly-Confidential |
| Finance | Design (Irrespective | Not Allow to Open File |
| | of Level) | with “Design” |

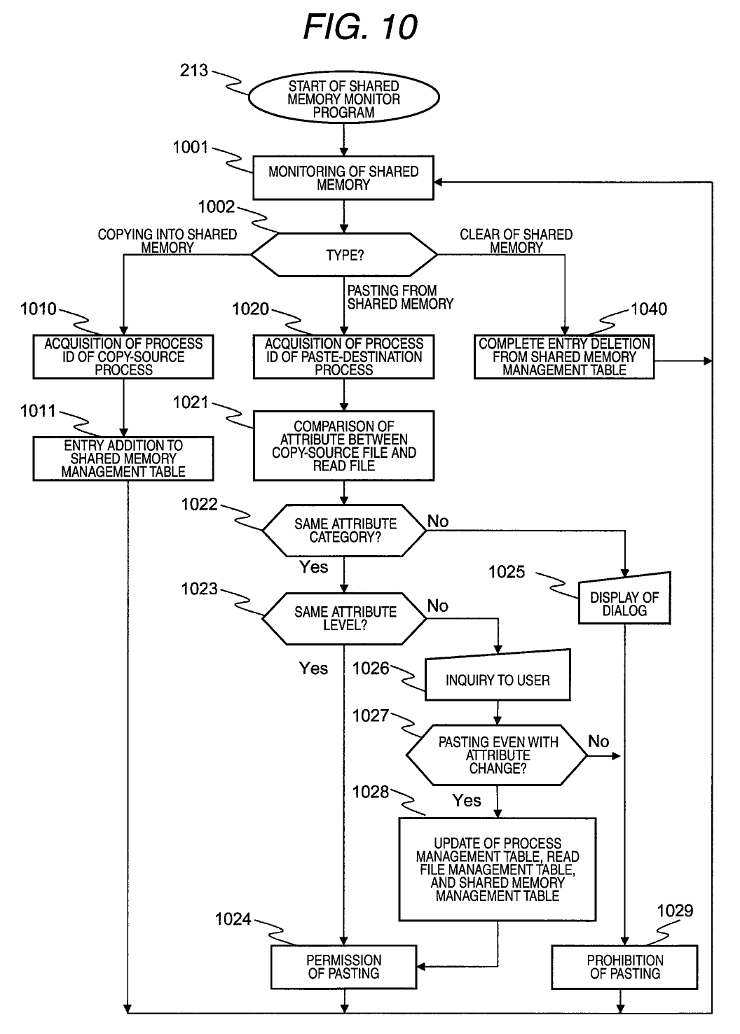

FIG. 10 is the flowchart diagram of the operation of the shared memory monitor program 213.

(Step 1001) When starting running, the shared memory monitor program 213 monitors the operation with respect to the shared memory 250.

(Step 1002) In accordance with the operation detected in step 1001, the shared memory monitor procedure thereafter is branched.

First of all, described is a case with data copying into the shared memory.

(Step 1010) When the copy operation is executed to the shared memory 250 in step 1002, the process ID of a main process of copying is acquired. As an example, noting that the window of copying is located at the forefront, the process ID of the window is acquired.

Alternatively, for copying of data of screen capture into the shared memory 250 using a PrintScreen key, the process ID of the forefront window may be acquired by making invalid the operation of the PrintScreen key for capturing the entire screen, and making valid the operation of an Alt+PrintScreen key for capturing only the forefront window.

Alternatively, the operation of screen capture by the PrintScreen key may be made valid, and the operation of the PrintScreen key may be made invalid while two or more windows that are finished or through with reading of files of various categories are open.

Still alternatively, the operation of screen capture by the PrintScreen key may be made valid, and while two or more windows through with reading of files of various categories are open, the process ID to be acquired in step 1010 may be acquired as the process ID of the window corresponding to the file highest in level.

(Step 1011) A new entry is added to shared memory management table 350. For entry addition as such, an entry is added while incrementing the number in the element of “stack order 521” assuming that a plurality of copies are to be stacked.

Described next is a case with data pasting from the shared memory.

(Step 1020) When the paste operation is executed from the shared memory 250 in step 1002, the process ID of a process of paste destination is acquired. As an example, noting that the window of paste destination is located at the forefront, the process ID of the window is acquired.

(step 1021) The following two attributes are compared to see whether the attribute of a copy source is the same as that of a paste destination:

the element of “copy source file attribute 523” under the pasted number in the element of “stack order 521” in the shared memory management table 350, and

the element of “READ file attribute 503” for the element of “process ID 501” same as the process ID acquired in step 1020 in the process management table 330.

(Step 1022) A determination is made whether the matching of attribute category is derived in step 1021 or not, and the procedure thereafter is branched.

(Step 1023) When the matching of attribute category is derived in step 1022, another determination is made whether matching of attribute level is derived in step 1021 or not, and the procedure thereafter is branched.

(Step 1024) When the matching of attribute category is derived together with the matching of attribute level in step 1023, a permission is given to data pasting.

(Step 1025) When the matching of attribute category is not derived in step 1022, a dialog is displayed for the user 50.

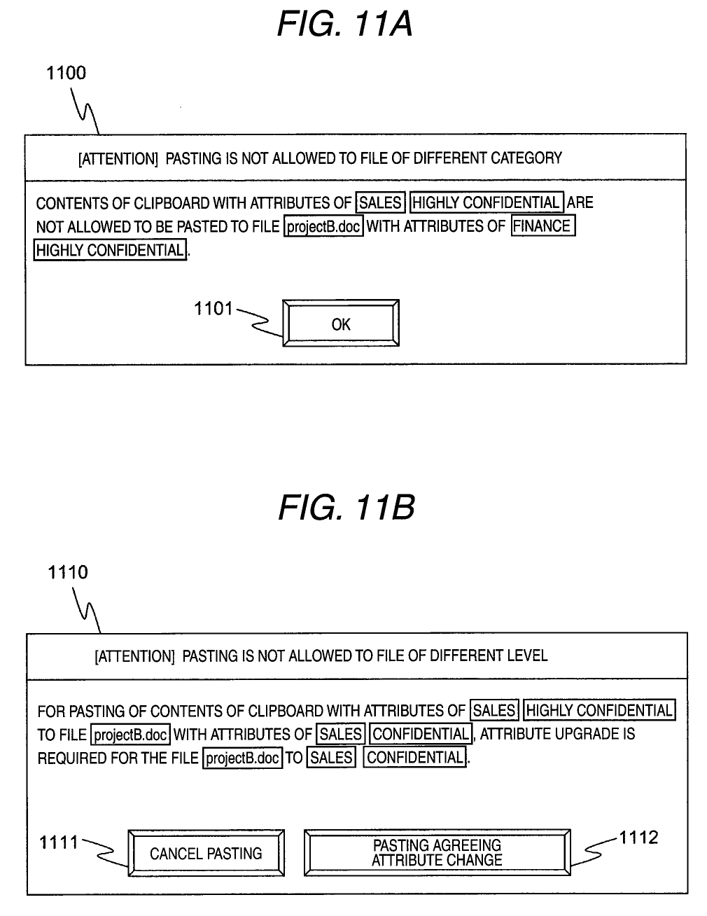

FIG. 11A is the diagram showing an exemplary dialog box 1100 to be displayed for the user 50 in step 1025. The dialog box 1100 indicates a message telling that no data pasting is allowed to the files with no matching of category, and the user is allowed only to depress a button 1101 for “OK”.

(Step 1026) When no matching of attribute level is derived in step 1023, an inquiry is made to the user 50.

FIG. 11B is the diagram showing an exemplary dialog box 1110 for making an inquiry to the user 50 in step 1008. The dialog box 1110 indicates a message telling that data pasting is to be performed to the files with various levels, and displays therein buttons 1111 and 1112. The button 1111 is provided for not to perform data pasting, and the button 1112 is for to perform pasting after the user becoming aware of the need for such an attribute change.

(Step 1027) The response from the user 50 in step 1026 is used as a basis to branch the procedure thereafter.

(Step 1028) When the user 50 agrees in step 1026 to perform pasting even with the change of attribute, that is, when the user depresses the button 1112, the new attribute indicated in the dialog 1110 is stored in the following three tables:

in the process management table 330, into the element of “READ file attribute 503”,

in the READ file management table 340, into the element of “attribute 513”, and

in the shared memory management table 350, into the element of “copy source file attribute 523”.

(Step 1029) When the determination is made that no pasting is performed in step 1026, i.e., the user 50 depresses the button 1111, a prohibition is issued not to perform pasting.

Described next is a procedure for clearing the shared memory.

(Step 1040) When the operation of clearing the shared memory 250 is executed in step 1001, all of the entries are deleted from the shared memory management table 350.

After such steps are completed, the procedure returns to step 1001 again, and the operation to the shared memory 250 is monitored. Until the client 10 is turned off, the procedure from steps 1001 to 1040 is repeated.

With the procedure executed by the shared memory monitor program 213, when the process tries to perform copying and pasting between files with various attributes, the control as shown in Table 2 is implemented over the pasting, for example.

TABLE 2

| Attribute of File | Attribute of File to be | |
|---|---|---|
| Copied into Shared | Pasted from Shared | Control Over Pasting |
| Memory | Memory | from Shared Memory |
| Confidential | Highly Confidential | Allow for Pasting |
| | (Same Category as | |
| | Left) | |
| Highly Confidential | Confidential (Same | Not Allow for Pasting, |
| | Category as Left) | or Allow for Pasting |
| | | After Changing |
| | | Attribute from |
| | | Confidential to |
| | | Highly-Confidential |
| Finance | Design (Irrespective | Not Allow for Pasting |
| | of Level) | |

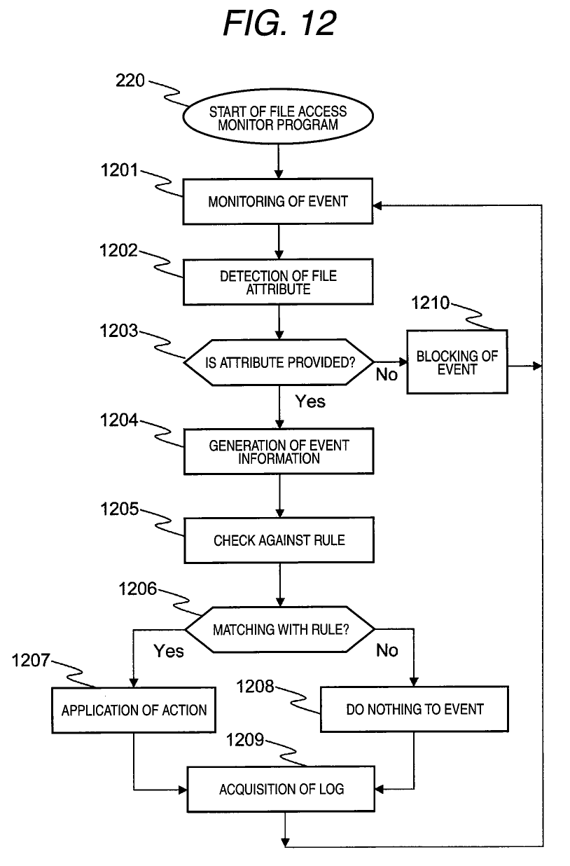

FIG. 12 is the flowchart diagram of the operation of the policy enforcement program 220.

(Step 1201) When starting running, the policy enforcement application program 220 monitors various events in the element of “event 231” to be occurred in the OS 230. Exemplary events are shown below.

1. Event closed in the client 10

File copy

File storage under a different name

File storage in a different format

File encryption

File compression

2. Event not closed in the client 10

File copy or transfer to other PCs over shared network

Transmission of e-mails with file attachment

Transmission of instant messengers with file attachment

Web upload

FTP (File Transfer Protocol) file transmission

Writing to CD-R (Compact Disk Recordable)/DVD-R (Digital Versatile Disc Recordable)

Writing to FD (Floppy Disk)

Writing to USB memory

Writing to DVD-RAM (Random-Access Memory)

Printing

(Step 1202) The attribute 2 of the file being a target of the event detected in step 1201.

(Step 1203) The procedure thereafter is branched depending on whether the attribute 2 is detected or not.

(Step 1204) When the attribute 2 is detected in step 1203, the event information 600 of FIG. 6 is generated.

(Step 1205) The event information 600 is checked against the rule in the rule management table 320 corresponding to the attribute 2 detected in step 1203.

(Step 1206) After step 1205, the procedure thereafter is branched depending on whether the matching of rule is derived or not, i.e., depending on whether the rule is matched to the element of “event 412” or to the element of “requirements 413”.

(Step 1207) When the matching of rule is derived in step 1206, the element of “action 414” in the rule management table 320 is applied.

(Step 1208) When the matching of rule is not derived in step 1206, the event 231 is not subjected to any procedure.

(Step 1209) The processing results of step 1207 or 1208 are logged (the log is not shown).

(Step 1210) When the attribute 2 is not detected in step 1203, the event 231 is entirely blocked.

After these steps are completed, the procedure returns to step 1201 again, and the next event is monitored. Until the client 10 is turned off, the procedure from steps 1201 to 1210 is repeated.

According to the first embodiment described above, in the method for providing an attribute to information resources, inheriting the attribute, and applying a policy in accordance with the attribute, after opening files with various attributes, for storing a file under a new file name after data overwriting from the files, control can be so applied as to inherit the attribute suiting the contents of the file not to be excessive. This accordingly helps both a user and a manager know with ease how to handle the file.

### Second Embodiment

In the second embodiment, described is a modified example of the file access monitor program 212. In the first embodiment, as shown in Table 1, when a process opens a file with the level of “confidential”, and when the same process opens another file with the level of “highly confidential”, there is only one option not to open the “highly-confidential” file, thereby reducing the convenience of use for the users. In the second embodiment, when the file with the level of “highly confidential” is to be opened later, the file with the level of “confidential” that has been opened first is put in a Read Only mode, thereby ensuring the convenience of use.

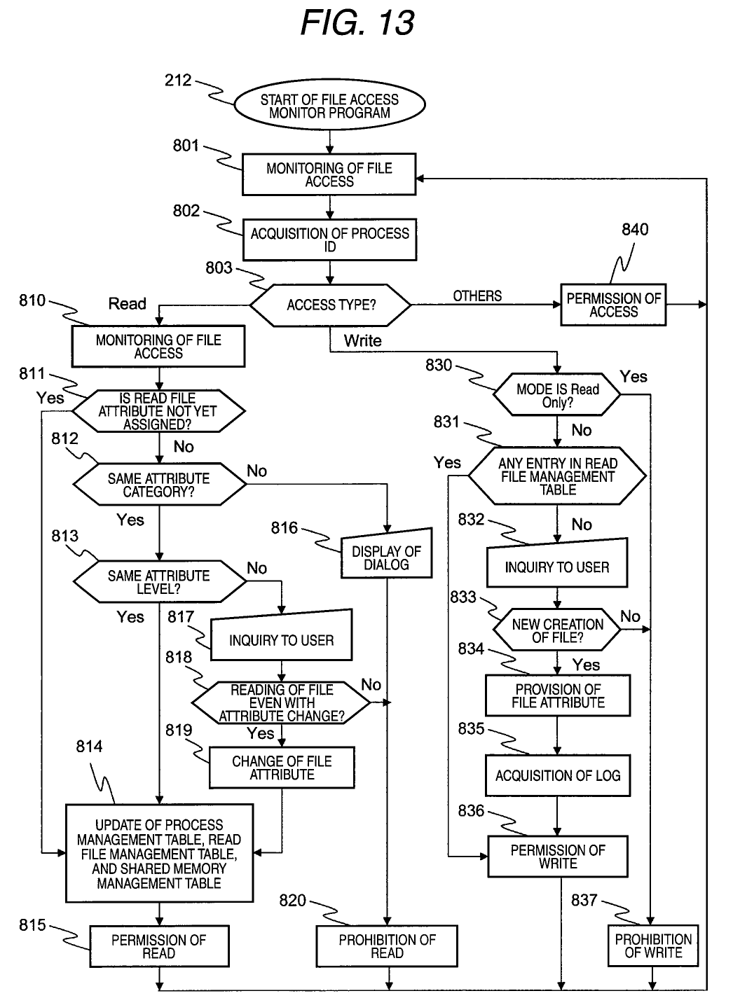

In the second embodiment, the system configuration is the same as that in the first embodiment, and for the data configuration thereof, the element of “mode 514” of FIG. 5 is used. As to the procedure flowchart, as shown in FIG. 13, a branched procedure is executed in step 830 in addition to the procedure of FIG. 8.

(Step 830) As to the file that is the access target of the file access detected in step 801, the element of “mode 514” is checked in the READ file management table 340, and the procedure thereafter is changed depending on whether the element of “mode 514” shows the Read Only mode. When the element of “mode 514” is showing the Read Only mode, the procedure goes to step 837, and otherwise the procedure goes to step 831.

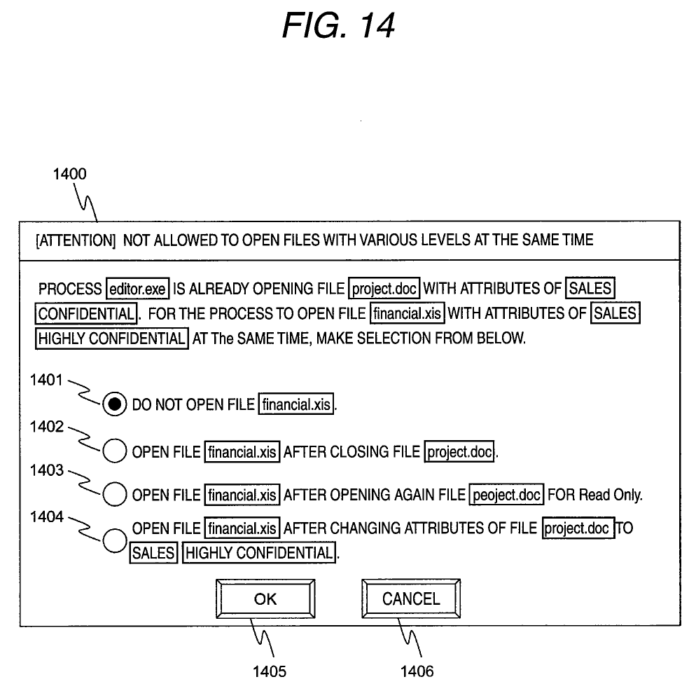

FIG. 14 shows an exemplary dialog box 1400 for display to the user 50 in the second embodiment. The dialog box 1400 is the replacement of the dialog 910 of FIG. 9B. The dialog box 1400 indicates a message telling that files varying in level cannot be both left open, and includes radio buttons 1401, 1402, and 1404, and a button 1403. The radio button 1401 is for not to open the files varying in level, the radio button 1402 is for to open one of the files, the button 1403 is for to open the files in the Read Only mode, and the radio button 1404 is for to open the files even the attribute is changed. The dialog box 1400 also includes an OK button 1405, and a cancel button 1406.

When the user 50 selects the radio button 1403, the element of “mode 514” is changed to Read Only in the READ file management table 340.

With the procedure executed by the file access monitor program 212 in the second embodiment, when the process makes an attempt to open files with various attributes all at once, the control as shown in Table 3 is implemented over the file access, for example.

TABLE 3

| Attribute of File | Attribute of File to be | |
|---|---|---|
| Being Opened by | Opened Next by Process | Control Over File |
| Process | Same as Left | Access |
| Confidential | Highly | Not Allow to Open |
| | Confidential (Same | Highly-Confidential |
| | Category as Left) | File, or Allow to Open |
| | | Highly-Confidential |
| | | File after Closing |
| | | Confidential File, or |
| | | Allow to Open |
| | | Highly-Confidential |
| | | File after Opening |
| | | again Confidential |
| | | File in Read Only |
| Highly Confidential | Confidential (Same | Not Allow to Open |
| | Category as Left) | Confidential File, or |
| | | Allow to Open |
| | | Confidential File in |
| | | Read Only, or Allow to |
| | | Open Confidential File |
| | | After Changing |
| | | Attribute to |
| | | Highly-Confidential |
| Finance | Design (Irrespective | Not Allow to Open File |
| | of Level) | with “Design” , or |
| | | Allow to Open both |
| | | Files of “Finance” and |
| | | “Design” in Read Only |

The information flow control is applicable to measures against information leakage in business industries handling a large amount of highly confidential identity information such as financial industry, medical industry, and public utility, measures against technology leakage in business industries handling information about intellectual property such as research-and-development division in pharmaceutical manufacturers, measures against security in corporations in charge of outsourcing with identity information and business information of customers, and stationary security management in corporations being the targets of information security monitoring.

As shown by the above discussion, functions relating to the information flow control may be implemented on computers connected for data communication via the components of a network, operating as the various server devices and/or client devices as shown in FIGS. 1 to 3. Although special purpose devices may be used, such devices also may be implemented using one or more hardware platforms intended to represent a general class of data processing device commonly used to run “server” and/or “client” programming so as to implement the functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the various polices, tables and managed information content. The software code is executable by the general-purpose computer that functions as the server and/or that functions as a client device. In operation, the code is stored within the general-purpose computer platform. At other times, however, the software may be stored at other locations and/or transported for loading into the appropriate general-purpose computer system. Execution of such code by a processor or central proceeding unit of the computer platform enables the platform to implement the technique for information flow control, in essentially the manner performed in the implementations discussed and illustrated herein.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. FIG. 3 shows exemplary elements of a client device. The hardware elements, operating systems and programming languages of such server and client devices are conventional in nature, and it is presumed that those skilled in the art are adequately familiar therewith. Of course, the server functions may be implemented in a distributed fashion on a number of similar platforms, to distribute the processing load.

Hence, aspects of the information flow control outlined above may be embodied in programming. Program aspects of the technology may be thought of as “products” or “articles of manufacture” typically in the form of executable code and/or associated data that is carried on or embodied in a type of machine readable medium. “Storage” type media include any or all of the memory of the computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the information flow control, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The specification and drawings are, accordingly, to be regarded in an illustrative rather than a restrictive sense. It will, however, be evident that various modifications and changes may be made thereto without departing from the spirit and scope of the invention(s) as set forth in the claims.

What is claimed is:

1. An information flow control system that provides an attribute to a file, and controls data transfer between the file and others varying in attributes, the system comprising:
process monitor means for process identification to know which process is started or ended, and keeping track of a list of processes in progress;
file read means for detecting, at the time of file reading, the attribute provided to the file being read; and
file write means for, at the time of file writing, providing the attribute to the file being written, wherein:
when the process reads a file with a second attribute after being through for reading of a file with a first attribute,
when the second attribute is higher in level than the first attribute, a user is allowed to select from among first control with which the file read means does not make the file with the second attribute open, second control with which the file read means makes the file with the second attribute open after closing the file with the first attribute, and third control with which the file read means makes the file with the second attribute open after opening again the file with the first attribute for read-only purpose,
when the user selects the first control, thereafter, the file write means provides the first attribute to a file to be written by the process, and
when the user selects the second or third control, thereafter, the file write means provides the second attribute to a file to be written by the process.

2. An information flow control system that provides an attribute to a file, and controls data transfer between the file and others varying in attributes, the system comprising:
process monitor means for process identification to know which process is started or ended, and keeping track of a list of processes in progress;
file read means for detecting, at the time of file reading, the attribute provided to the file being read; and
file write means for, at the time of file writing, providing the attribute to the file being written, wherein:
when the process reads a file with a second attribute after being through for reading of a file with a first attribute,
when the second attribute is lower in level than the first attribute, a user is allowed to select from among first control with which the file read means does not make the file with the second attribute open, second control with which the file read means makes the file with the second attribute open after changing the attribute thereof to the first attribute, and third control with which the file read means makes the file with the second attribute open for read-only purpose, and
thereafter, the file write means provides the first attribute to a file to be written by the process.

3. An information flow control system that provides an attribute to a file, and controls data transfer between the file and others varying in attributes, the system comprising:
process monitor means for process identification to know which process is started or ended, and keeping track of a list of processes in progress;
file read means for detecting, at the time of file reading, the attribute provided to the file being read; and
file write means for, at the time of file writing, providing the attribute to the file being written, wherein:
when the process reads a file with a second attribute after being through for reading of a file with a first attribute,
when the second attribute is different in category from the first attribute, a user is allowed to select from among first control with which the file read means does not make the file with the second attribute open, second control with which the file read means makes the file with the second attribute open after opening again the file with the first attribute for read-only purpose, and third control with which the file read means makes the file with the second attribute open for read-only purpose,
when the user selects the first or third control, thereafter, the file write means provides the first attribute to a file to be written by the process, and
when the user selects the second control, thereafter, the file write means provides the second attribute to a file to be written by the process.

4. The information flow control system according to claim 1, further comprising:
shared memory copy detection means for detecting copying to a shared memory; and
shared memory paste detection means for detecting pasting from the shared memory, wherein;
when a second process being through with reading of the file with the second attribute performs pasting from the shared memory after a first process performs copying to the shared memory from the file with the first attribute, and when the second attribute is higher in level than the first attribute, then the shared memory paste detection means performs fourth control for giving permission to pasting, and
thereafter, the file write means provides the second attribute to a file to be written by the second process.

5. The information flow control system according to claim 2, further comprising:
shared memory copy detection means for detecting copying to a shared memory; and
shared memory paste detection means for detecting pasting from the shared memory, wherein:
when a second process being through with reading of the file with the second attribute performs pasting from the shared memory after a first process performs copying to the shared memory from the file with the first attribute, and when the second attribute is higher in level than the first attribute, then the shared memory paste detection means performs fourth control for giving permission to pasting, and
thereafter, the file write means provides the second attribute to a file to be written by the second process.

6. The information flow control system according to claim 3, further comprising:
shared memory copy detection means for detecting copying to a shared memory; and
shared memory paste detection means for detecting pasting from the shared memory, wherein:
when a second process being through with reading of the file with the second attribute performs pasting from the shared memory after a first process performs copying to the shared memory from the file with the first attribute, and when the second attribute is higher in level than the first attribute, then the shared memory paste detection means performs fourth control for giving permission to pasting, and
thereafter, the file write means provides the second attribute to a file to be written by the second process.

7. The information flow control system according to claim 1, further comprising:
shared memory copy detection means for detecting copying to a shared memory; and
shared memory paste detection means for detecting pasting from the shared memory, wherein:
when a second process being through with reading of the file with the second attribute performs pasting from the shared memory after a first process performs copying to the shared memory from the file with the first attribute, and when the second attribute is lower in level than the first attribute, then a user is allowed to select from among fourth control with which the shared memory paste detection means performs no pasting and fifth control with which the shared memory paste detection means performs pasting after changing the file with the second attribute to have the first attribute,
when the user selects the fourth control, thereafter, the file write means provides the second attribute to a file to be written by the second process, and
when the user selects the fifth control, thereafter, the file write means provides the first attribute to a file to be written by the second process.

8. The information flow control system according to claim 2, further comprising:
shared memory copy detection means for detecting copying to a shared memory; and
shared memory paste detection means for detecting pasting from the shared memory, wherein:
when a second process being through with reading of the file with the second attribute performs pasting from the shared memory after a first process performs copying to the shared memory from the file with the first attribute, and when the second attribute is lower in level than the first attribute, a user is allowed to select from among fourth control with which the shared memory paste detection means performs no pasting, and fifth control with which the shared memory paste detection means performs pasting after changing the file with the second attribute to have the first attribute,
when the user selects the fourth control, thereafter, the file write means provides the second attribute to a file to be written by the second process, and
when the user selects the fifth control, thereafter, the file write means provides the first attribute to a file to be written by the second process.

9. The information flow control system according to claim 3, further comprising:
shared memory copy detection means for detecting copying to a shared memory; and
shared memory paste detection means for detecting pasting from the shared memory, wherein:
when a second process being through with reading of the file with the second attribute performs pasting from the shared memory after a first process performs copying to the shared memory from the file with the first attribute, and when the second attribute is lower in level than the first attribute, then a user is allowed to select from among fourth control with which the shared memory paste detection means performs no pasting, and fifth control with which the shared memory paste detection means performs pasting after changing the file with the second attribute to have the first attribute,
when the user selects the fourth control, thereafter, the file write means provides the second attribute to a file to be written by the second process, and
when the user selects the fifth control, thereafter, the file write means provides the first attribute to a file to be written by the second process.

10. The information flow control system according to claim 1, further comprising:
shared memory copy detection means for detecting copying to a shared memory; and
shared memory paste detection means for detecting pasting from the shared memory, wherein:
when a second process being through with reading of the file with the second attribute performs pasting from the shared memory after a first process performs copying to the shared memory from the file with the first attribute, and when the second attribute is different in category from the first attribute, then the shared memory paste means performs fourth control with no pasting, and
thereafter, the file write means provides the second attribute to a file to be written by the second process.

11. The information flow control system according to claim 2, further comprising:
shared memory copy detection means for detecting copying to a shared memory; and
shared memory paste detection means for detecting pasting from the shared memory, wherein:
when a second process being through with reading of the file with the second attribute performs pasting from the shared memory after a first process performs copying to the shared memory from the file with the first attribute, and when the second attribute is different in category from the first attribute, then the shared memory paste means performs fourth control with no pasting, and
thereafter, the file write means provides the second attribute to a file to be written by the second process.

12. The information flow control system according to claim 3, further comprising:
shared memory copy detection means for detecting copying to a shared memory; and
shared memory paste detection means for detecting pasting from the shared memory, wherein:
when a second process being through with reading of the file with the second attribute performs pasting from the shared memory after a first process performs copying to the shared memory from the file with the first attribute, and when the second attribute is different in category from the first attribute, then the shared memory paste means performs fourth control with no pasting, and
thereafter, the file write means provides the second attribute to a file to be written by the second process.

13. The information flow control system according to claim 1, wherein:
when a process writes a new file with no file reading, a user is allowed to select from among fourth control with which the file write means creates no new file and fifth control with which the file write means creates a file after provision of the attribute, and
when the user selects the fifth control, thereafter, the file write means provides the attribute to a file to be written by the process.

14. The information flow control system according to claim 2, wherein:
when a process writes a new file with no file reading, a user is allowed to select from among fourth control with which the file write means creates no new file and fifth control with which the file write means creates a file after provision of the attribute, and
when the user selects the fifth control, thereafter, the file write means provides the attribute to a file to be written by the process.

15. The information flow control system according to claim 3, wherein:
when a process writes a new file with no file reading, a user is allowed to select from among fourth control with which the file write means creates no new file and fifth control with which the file write means creates a file after provision of the attribute, and
when the user selects the fifth control, thereafter, the file write means provides the attribute to a file to be written by the process.

16. The information flow control system of claim 1, wherein:
the system further comprises at least one central processing unit and at least one program storage medium; and
each means comprises programming contained in the storage medium executable on the at least one central processing unit.

17. The information flow control system of claim 2, wherein:
the system further comprises at least one central processing unit and at least one program storage medium; and
each means comprises programming contained in the storage medium executable on the at least one central processing unit.

18. The information flow control system of claim 3, wherein:
the system further comprises at least one central processing unit and at least one program storage medium; and
each means comprises programming contained in the storage medium executable on the at least one central processing unit.

19. An article of manufacture comprising:
a machine readable storage medium; and
executable programming carried by the machine readable storage medium, the programming comprising:
process monitor programming for process identification to know which process is started or ended, and keeping track of a list of processes in progress;
file read programming for detecting, at the time of file reading, the attribute provided to the file being read; and
file write programming for, at the time of file writing, providing the attribute to the file being written, wherein:
when the process reads a file with a second attribute after being through for reading of a file with a first attribute,
when the second attribute is higher in level than the first attribute, a user is allowed to select from among first control with which the file read programming does not make the file with the second attribute open, second control with which the file read programming makes the file with the second attribute open after closing the file with the first attribute, and third control with which the file read programming makes the file with the second attribute open after opening again the file with the first attribute for read-only purpose,
when the user selects the first control, thereafter, the file write programming provides the first attribute to a file to be written by the process, and
when the user selects the second or third control, thereafter, the file write programming provides the second attribute to a file to be written by the process.

20. An article of manufacture comprising:
a machine readable storage medium; and
executable programming carried by the machine readable storage medium, the programming comprising:
process monitor programming for process identification to know which process is started or ended, and keeping track of a list of processes in progress;
file read programming for detecting, at the time of file reading, the attribute provided to the file being read; and
file write programming for, at the time of file writing, providing the attribute to the file being written, wherein:
when the process reads a file with a second attribute after being through for reading of a file with a first attribute,
when the second attribute is lower in level than the first attribute, a user is allowed to select from among first control with which the file read programming does not make the file with the second attribute open, second control with which the file read programming makes the file with the second attribute open after changing the attribute thereof to the first attribute, and third control with which the file read programming makes the file with the second attribute open for read-only purpose, and
thereafter, the file write programming provides the first attribute to a file to be written by the process.

21. An article of manufacture comprising:
a machine readable storage medium; and
executable programming carried by the machine readable storage medium, the programming comprising:
process monitor programming for process identification to know which process is started or ended, and keeping track of a list of processes in progress;
file read programming for detecting, at the time of file reading, the attribute provided to the file being read; and
file write programming for, at the time of file writing, providing the attribute to the file being written, wherein:
when the process reads a file with a second attribute after being through for reading of a file with a first attribute,
when the second attribute is different in category from the first attribute, a user is allowed to select from among first control with which the file read programming does not make the file with the second attribute open, second control with which the file read programming makes the file with the second attribute open after opening again the file with the first attribute for read-only purpose, and third control with which the file read programming makes the file with the second attribute open for read-only purpose,
when the user selects the first or third control, thereafter, the file write programming provides the first attribute to a file to be written by the process, and
when the user selects the second control, thereafter, the file write programming provides the second attribute to a file to be written by the process.
